(19) United States
(12) Patent Application Publication
(10) Pub. No.: US 2024/0229525 A1
(43) Pub. Date: Jul. 11, 2024

(54) GATE PROP DEVICE

(71) Applicants: Thomas Olsen, Pauls Valley, OK (US); Marcia Hyatt, Pauls Valley, OK (US)

(72) Inventors: Thomas Olsen, Pauls Valley, OK (US); Marcia Hyatt, Pauls Valley, OK (US)

(21) Appl. No.: 18/404,893

(22) Filed: Jan. 5, 2024

Related U.S. Application Data
(60) Provisional application No. 63/437,352, filed on Jan. 5, 2023.

(51) Int. Cl. E05C 17/44

(52) U.S. Cl. CPC E05C 17/443

(57) ABSTRACT

A gate prop device is disclosed herein and includes a main body having a second portion inserted into a first portion to enable a length of the gate prop device to be adjusted. The gate prop device attaches to a gate to prevent the gate from being moved, particularly by the wind. A sharp, or rounded end of the second portion pierces a ground beneath the gate to prevent the gate prop device from moving. The gate prop device is compact and is able to be folded and stored on the gate such that the gate prop device is easily accessible for use in propping open the gate when needed.

### CROSS-REFERENCE TO RELATED APPLICATIONS

This application claims the benefit of U.S. Provisional Patent Application Ser. No. 63/437,352 filed on Jan. 5, 2023, which is incorporated by reference herein in its entirety.

### FIELD OF THE INVENTION

The present invention generally relates to the field of gates and more specifically relates to a device for propping open a gate.

### BACKGROUND OF THE INVENTION

Gates serve as fundamental components for controlling access, providing a means to secure spaces and manage the flow of people, vehicles, or animals. In urban environments, gates play a crucial role in delineating property boundaries, enhancing security, and regulating traffic. Whether in residential areas, industrial complexes, or public spaces, gates act as physical barriers that can be opened or closed, granting or restricting passage based on specific criteria.

Farm gates play a crucial role in the daily operations of agricultural settings, serving as essential barriers and access points within the farm infrastructure. These gates are designed to provide security, control livestock movement, and facilitate the efficient flow of both animals and machinery.

Typically made from durable materials such as steel or wood, farm gates are constructed to withstand the rigors of outdoor exposure and the unpredictable weather conditions often experienced in rural environments. The design of these gates varies based on their intended purpose, with some serving as entry points for vehicles and larger equipment, while others are tailored to manage the movement of livestock.

Propping open gates is occasionally deemed necessary for practical reasons in certain contexts. In agricultural settings, for example, farmers may prop open gates to facilitate the easy movement of livestock, allowing animals to graze freely between different pastures or access feeding areas.

This practice can enhance efficiency in daily farm operations, minimizing the need for constant manual opening and closing of gates. In addition, propping open gates can serve as a temporary solution when there is a continuous flow of traffic, such as during harvesting or transportation of goods, ensuring smooth movement without constant interruption.

The current means of propping open gates, often relying on rudimentary methods such as rocks, bricks, or other improvised objects, pose inherent challenges, particularly in the face of environmental factors like wind.

One significant problem arises when wind forces act on the gate, causing it to be blown either forward or backward, leading to potential safety hazards and compromising the intended purpose of the gate.

The instability introduced by such makeshift solutions not only jeopardizes the security or containment provided by the gate but also poses a risk of damage to the gate itself. This lack of reliability in propping open gates becomes especially pronounced in areas prone to strong winds, storms, or sudden weather changes. As such, a suitable solution is desired.

### SUMMARY OF THE INVENTION

The present invention is directed to a gate prop device. The gate prop device advantageously addresses the aforementioned deficiencies by providing a stable, compact prop that attaches to a gate and is able to be moved into an in-use position to prop the gate in an open position. Thus, the aforementioned problems associated with inadvertent movement of gates, are avoided.

In a first implementation of the invention, a gate prop device may include a main body having a first portion and a second portion. The first portion may include a hollow tube and the second portion may include a solid rod configured for insertion into an interior of the first portion. As such, the gate prop device may be adjustable in length.

The first portion may include a first portion first end, a first portion second end opposite the first portion first end and a first portion length therebetween. Similarly, the second portion may include a second portion first end, a second portion second end opposite the second portion first end and a second portion length therebetween. In some embodiments, the second portion second end may terminate with a point.

The second portion first end of the second portion may be inserted into the first portion and configured to slidably move therewithin to enable the length of the gate prop device to be adjusted.

In a second aspect, an adjuster may be located on the first portion of the gate prop device. Particularly, the adjuster may be located on the first portion length and configured to lock the second portion to the first portion at a desired position relative to the second portion, and thereby, the adjuster locks the gate prop device at a desired length.

The adjuster may include a thumb screw configured to insert into an aperture located within the first portion. The thumb screw may include a top handle element attached atop a screw element configured for insertion into the aperture and configured to contact the second portion length of the second portion within the first portion.

In another aspect, a swivel connector may be attached to the first portion first end of the first portion and a first clamp may be attached toward the first portion first end of the first portion. The first clamp may be configured to attached to a horizontal beam of a gate on which the gate prop device is being attached. In particular, the first clamp may be configured to mount approximately 2 (two) inches from an opening side of a gate.

The first clamp may include a first U-shaped configuration including a first pair of downwardly extending legs and a first top therebetween.

In some embodiments, the swivel connector may be attached to the first clamp. Particularly, the first swivel connector may include an aperture configured to receive a slotted flat head machine screw to hold the swivel connector to the first top of the first clamp.

The swivel connector may allow the first portion to pivot relative the swivel connector, moving the gate prop between an in-use position and a not in-use position. In the in-use position, the first portion may be generally angled and contacting the ground to prop the gate open; and in the not-in use position, the first portion may be generally horizontal, parallel to a horizontal shaft of the gate and not propping the gate open.

The swivel connector may also enable the gate prop to be placed on either side of the gate to which it is being attached, thereby stopping the gate from being moved in either direction.

In another aspect, a second clamp may be provided with the gate prop device. The second clamp may be configured to attached to the same horizontal beam as the first clamp, further along a length of the horizontal beam.

Similar to the first clamp, the second clamp may include a second U-shaped configuration including a second pair of downwardly extending legs and a second top therebetween.

In another aspect, a prop holding member may be attached to the second top of the second clamp. In some embodiments, the prop holding member may include a third U-shaped configuration including a pair of upwardly extending legs.

In another aspect, the first portion may be made from a metal material and the second portion may be made from a rebar material. The swivel connector may be made from a flat steel material. The first clamp and the second clamp may be made from a metal material with zinc coated bolts to fasten the clamps to the gate.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a front perspective view of a gate prop device including a first portion and a second portion, according to one or more embodiments of the present invention;

FIG. 2 presents a front perspective of the gate prop device attached to a gate in an in-use position being used to prop the gate in an open position, according to one or more embodiments of the present invention; and

FIG. 3 presents a front perspective view of the gate prop device attached to the gate and in a not-in use position, according to one or more embodiments of the present invention.

Like reference numerals refer to like parts throughout the several views of the drawings.

### DETAILED DESCRIPTION

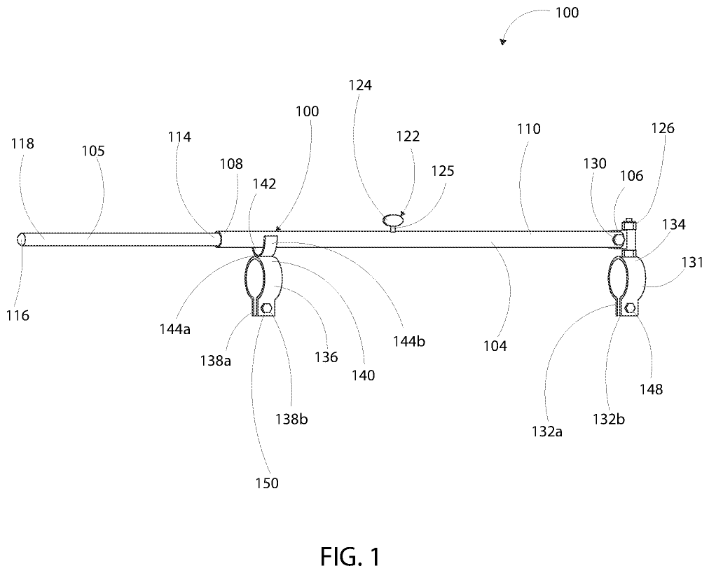

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

It should be appreciated that the term “comprising” can also encompass the terms “consisting essentially of” and “consisting of”.

Shown throughout the figures, the present invention is directed toward a gate prop device. The gate prop device is configured to attach to a gate to prevent the gate from being moved, particularly by the wind. The gate prop device is compact and is able to be folded and stored on the gate such that the gate prop device is easily accessible.

Referring initially to FIG. 1, there is shown a front perspective view of a gate prop device 100. The gate prop device 100 may include a main body that is able to be locked into various lengths. Particularly, as shown here, the main body may include a first portion 104 and a second portion 105.

The first portion 104 may include a first portion first end 106, a first portion second end 108 opposite the first portion first end 106, a first portion length 110 therebetween and a first portion longitudinal axis defined between the first portion first end 106 and the first portion second end 108.

Similarly, the second portion 105 may include a second portion first end 114, a second portion second end 116 opposite the second portion first end 114, a second portion length 118 therebetween and a second portion longitudinal axis defined between the second portion first end 114 and the second portion second end 116. In some embodiments, the second portion second end 116 may terminate with a point, or a rounded edge.

In some embodiments, the first portion 104 may include a length of 18 (eighteen) inches, as measured from the first portion first end 106 and the first portion second end 108. The second portion 105 may include a length of 24 (twenty-four) inches, as measured from the second portion first end 114 and the second portion second end 116. Further, in some embodiments, the second portion 105 may include a diameter of ⅜ of an inch. It should however be appreciated that the first portion 104 and the second portion 105 are not limited to these measurements.

The first portion 104 may include a hollow tube and the second portion 105 may include a solid rod configured for insertion into an interior of the first portion 104. Particularly, the second portion first end 114 of the second portion 105 may be inserted into the first portion 104 and configured to slidably move therewithin to enable the length of the gate prop device 100 to be adjusted.

In some embodiments, the first portion 104 may be made from a metal material and the second portion 105 may be made from a rebar material.

As shown in FIG. 1, an adjuster 122 may be located on the first portion 104 of the gate prop device 100. Particularly, the adjuster 122 may be located on the first portion length 110, toward the first portion second end 108 of the first portion 104. The adjuster 122 may be configured to lock the second portion 105 to the first portion 104 at a desired position relative to the second portion 105. As such, the adjuster 122 is able to be used to lock the gate prop device 100 at a desired length. In some embodiments, the adjuster 122 may include a thumb screw configured to insert into an aperture (not illustrated) located within the first portion 104.

In some embodiments, the aperture may include a diameter of ⅛ of an inch and may be located 4 (four) inches from the first portion second end 108 of the first portion 104. The thumb screw may include a screw element 125 having a diameter of ¼ of an inch. It should however be appreciated that the adjuster 122 and the aperture are not limited to these measurements.

The thumb screw may include a top handle element 124 attached atop the screw element 125. For example, the handle element 124 may include a generally flat circular body to enable a user to easily grasp the thumb screw. The screw element 125 may be configured for insertion into the aperture and configured to contact the second portion length 118 of the second portion 105 within the first portion 104.

Accordingly, to adjust a length of the gate prop device 100, a user may grasp the flat circular body of the top handle element 124 and unscrew the screw element 125 to loosen the second portion 105 within the first portion 104.

The user may then adjust a position of the second portion 105 relative to the first portion 104 by inserting the second portion 105 further into the first portion 104 or moving the second portion 105 further out of the first portion 104. Once at a desired position, the user may then again grasp the flat circular body of the top handle element 124 and screw the screw element 125 into the aperture to tighten the second portion 105 within the first portion 104.

In some embodiments, a swivel connector 126 may be attached to the first portion first end 106 of the first portion 104. The first portion first end 106 may include a long notch and an aperture (not illustrated) to mount the swivel connector 126 to the first portion 104. Further, the swivel connector 126 may include a flat steel bar attached to a metal tube and a bolt and lock nut combination 130 to attach to the first portion 104.

In some embodiments, the bar may be ⅛ by ¾ and 1¼ inches long with a ¼ inch aperture and the metal tube may include an outer diameter (OD) of ½ inch, an inner diameter (ID) of 0.370 inches and a length of 1 (one) inch. The long notch may include a width of ⅛ an inch and a length of 1 inch and the aperture may include a diameter of ¼ an inch. Further, the bolt and lock nut 130 may include a diameter of ¼ of an inch. Again, it should be appreciated that these elements are not limited to the discussed measurements.

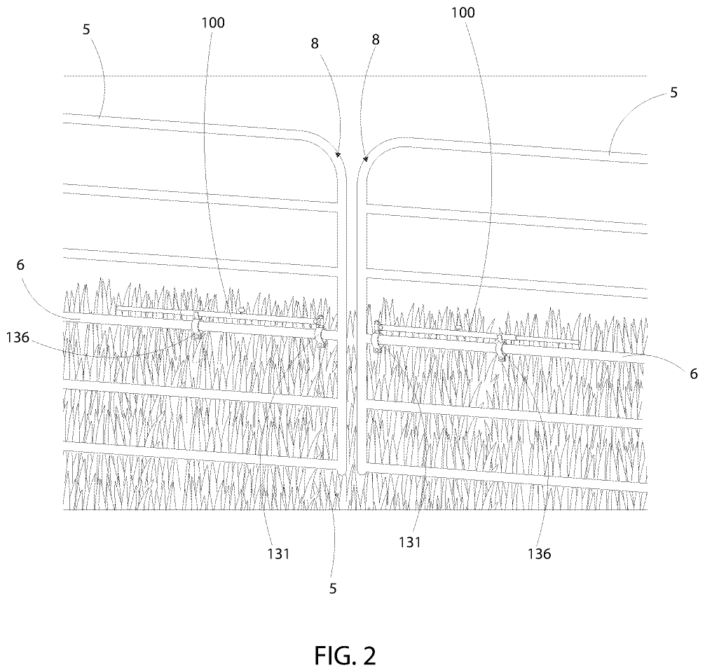

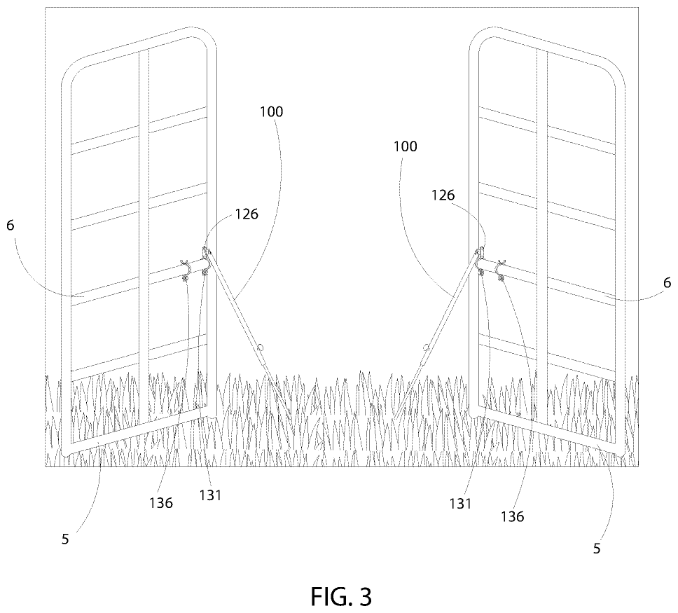

A first clamp 131 may be attached toward the first portion first end 106 of the first portion 104. The first clamp 131 may be configured to attached to a horizontal beam 6 of a gate 5 on which the gate prop device 100 is being attached (FIGS. 2-3). In particular, the first clamp 131 may be configured to mount approximately 2 (two) inches from an opening side 8 of a gate 5.

As shown in FIG. 1, the first clamp 131 may include a first U-shaped configuration including a first pair of downwardly extending legs 132 a, 132 b and a first top 134 therebetween. The swivel connector 126 may be attached to the first clamp 131. Particularly, the swivel connector 126 may include a swivel connector aperture (not illustrated) configured to receive a screw to hold the swivel connector 126 to the first top 134 of the first clamp 131. In some embodiments, the screw may be a slotted flat head machine screw.

Further, in some embodiments, the first swivel connector aperture may include a diameter of 5/16 of an inch and the screw may include a diameter of 5/16 of an inch and a length of 2 (two) inches configured to fit into the aperture. It should however be appreciated that the swivel connector aperture and the screw are not limited to these measurements.

In another aspect, as shown in FIG. 1, a second clamp 136 may be provided with the gate prop device 100. The second clamp 136 may be configured to attached to the same horizontal beam 6 of the gate 5 as the first clamp 131, further along a length of the horizontal beam 6. As shown here, similar to the first clamp 131, the second clamp 136 may include a second U-shaped configuration including a second pair of downwardly extending legs 138 a, 138 b and a second top 140 therebetween.

As shown here, in another aspect, a prop holding member 142 may be attached to the second top 140 of the second clamp 136. In some embodiments, the prop holding member 142 may include a third U-shaped configuration including a pair of upwardly extending legs 144 a, 144 b.

Further, as shown here, a first bolt 148 may be threaded through a first pair of aligned apertures (not illustrated) each disposed in one of the first pair of downwardly extending legs 132 a, 132 b of the first clamp 131 to attach the first clamp 131 to the gate 5. Similarly, a second bolt 150 may be threaded through a second pair of aligned apertures (not illustrated) each disposed in one of the second pair of downwardly extending legs 138 a, 138 b of the second clamp 136 to attach the second clamp 136 to the gate 5.

In some embodiments the aligned apertures of both clamps 131, 136 may be 2 (two) inches in diameter and configured to receive 5/16 zinc coated bolts 148, 150. In some embodiments, the bolts 148, 150 may be 1 (one) inch in length and include 5/16 inch lock nuts.

Referring now to FIGS. 2-3, there are shown front perspective views of the gate prop device 100 attached to the gate 5. Particularly, FIG. 2 illustrates a front perspective view of the gate prop device 100 in an in-use position and FIG. 3 illustrates a front perspective view of the gate prop device 100 in a not in-use position. As shown here, for gates comprising two halves, one device 100 may be placed on each half of the gate.

As above, the swivel connector 126 may be attached to the first clamp 131, which in turn may be attached to the gate 5. To attach the first clamp 131 to the gate 5, the first bolt 148 may be threaded through the first pair of aligned apertures each disposed in one of the first pair of downwardly extending legs 132 a, 132 b. Particularly, as shown here, the horizontal beam 6 of the gate 5 may be inserted into a space defined by the first pair of downwardly extending legs 132 a, 132 b approximately 2 (two) inches from the opening side 8 of the gate 5. The first bolt 148 may then be threaded through the first pair of aligned apertures, underneath the horizontal beam 6 of the gate 5.

As above and as shown here, the swivel connector 126 may allow the first portion 104 to pivot relative the swivel connector 126, moving the gate prop device 100 between an in-use position and a not in-use position. As shown in FIG. 2, in the in-use position, the first portion 104 may be angled to or generally vertical and contacting the ground 7 to prop the gate 5 open. Particularly, the first portion longitudinal axis and the second portion longitudinal axis may be angled to or generally vertical to the ground 7 and the horizontal beam 6 of the gate 5.

As shown in FIG. 2, the second portion second end 116 may be the portion of the gate prop device 100 to contact a ground surface 7 when the gate prop device 100 is in the in-use position and being used to prop the gate 5 open. As such, as discussed above, the second portion second end 116 of the second portion 105 may terminate in a point. This may enable the second portion second end 116 of the second end to pierce the ground surface 7, which stabilizes the gate prop device 100 and prevents movement of the gate 5.

It is preferable that the swivel connector 126 may also enable the gate prop device 100 to be placed on either side of the gate 5 to which it is being attached, thereby stopping the gate 5 from being moved in either direction.

FIG. 3 illustrates the gate prop device 100 in the not in-use position. As shown here, in the not-in use position, the first portion 104 may be generally horizontal, parallel to the horizontal beam 6 of the gate 5 and not propping the gate 5 open. Particularly, the first portion longitudinal axis and the second portion longitudinal axis may be generally parallel to the ground 7 and the horizontal beam 6 of the gate 5.

As above, the second clamp 136 may also be configured to attach to the horizontal beam 6 of the gate 5, which as shown here may be located further down the horizontal beam 6 than the first clamp 131, further away from the opening side 8 of the gate 5. Particularly, in some embodiments, the second clamp 136 may be located (but is not limited to being located) 18 (eighteen) inches away from the first clamp 131 on the gate 5.

The second clamp 136 may attach to the gate 5 in a same or similar fashion as the first clamp 131. Particularly, the second bolt 150 may be threaded through the second pair of aligned apertures each disposed in one of the second pair of downwardly extending legs 138 a, 138 b. As shown here, the horizontal beam 6 of the gate 5 may be inserted into a space defined by the second pair of downwardly extending legs 138 a, 138 b approximately 2 (two) inches from the opening side 8 of the gate 5. The second bolt 150 may then be threaded through the second pair of aligned apertures, underneath the horizontal beam 6 of the gate 5.

As above, the prop holding member 142 may be attached to the second top 140 of the second clamp 136 and may include the third U-shaped configuration having the pair of upwardly extending legs 144 a, 144 b. As shown in FIG. 1 and FIG. 3, the prop holding member 142 may be configured to hold the main body of the gate prop device 100 when in the not in-use position. Particularly, a portion of the second portion 105 may rest within a space defined between the pair of upwardly extending legs 144 a, 144 b of the prop holding member 142. This may enable the gate prop device 100 to remain on the gate 5 when not in use, allowing easy access to the gate prop device 100 when need to prop the gate 5 open.

In use, a user may attach the gate prop device 100 to the horizontal beam 7 of the gate 5 by attaching the first clamp 131 to the horizontal beam 7, approximately 2 (two) inches from the opening side 8 of the gate 5. Approximately 18 (eighteen) inches away from the first clamp 131, the second clamp 136 may then be attached. The clamps 131, 136 again may be attached via the bolts 148, 150. As above, for gates with two (or more) halves, one gate prop device 100 may be placed on each half.

When the user desires to prop the gate 5 open, the user may then swivel the gate prop device 100, via the swivel connector 126, into an in-use position where the gate prop device 100 is either angled or generally vertical relative to the ground 7. The user may particularly pierce the ground 7 with the second portion second end 108 of the second portion 105 to stabilize the gate prop device 100 and prevent movement thereof. As such, the gate 5 is then propped open.

Once the user desires to close the gate 5, the user may then swivel the gate prop device 100, again via the swivel connector 126 into a not in-use position where the gate prop device 100 is generally parallel to the ground 7. The user may place the gate prop device 100 into the prop holding member 142.

In some embodiments, the user may also adjust the length of the gate prop device 100 by utilizing the adjuster 122 to loosen and tighten the second portion 105 relative to the first portion 104.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A gate prop device, said gate prop device comprising:
a main body having a first portion and a second portion;
a first portion first end;
a first portion second end;
a first portion length located in between said first portion first end and said first portion second end;
a second portion first end;
a second portion second end;
a second portion length located in between said second portion first end and said second portion second end;

2. The gate prop device of claim 1, wherein said first portion includes a hollow tube.

3. The gate prop device of claim 1, wherein said second portion includes a solid rod.

4. The gate prop device of claim 1, wherein said second portion is configured to be inserted into an interior of said first portion.

5. The gate prop device of claim 1, wherein said device is adjustable in length.

6. The gate prop device of claim 4, wherein said second portion is configured to slidably move within said interior of said first portion.

7. The gate prop device of claim 1, wherein said device further includes an adjuster.

8. The gate prop device of claim 7, wherein said adjuster is a thumb screw.

9. The gate prop device of claim 7, wherein said adjuster is configured to be inserted into an aperture located on said first portion.

10. The gate prop device of claim 8, wherein said thumb screw includes a top handle element attached atop a screw element configured to be inserted into an aperture and configured to contact said second portion length of said second portion within said first portion.

11. The gate prop device of claim 1, wherein said device further includes a swivel connector attached to said first portion first end of said first portion.

12. The gate prop device of claim 11, wherein a first clamp is attached toward said first portion first end of said first portion.

13. The gate prop device of claim 1, wherein a first clamp is configured to attach to a horizontal beam of a gate.

14. The gate prop device of claim 13, wherein said first clamp is configured to mount approximately 2 (two) inches from an opening side of a gate.

15. The gate prop device of claim 14, wherein said first clamp includes a first U-shaped configuration.

16. The gate prop device of claim 15, wherein said first U-shaped configuration includes a first pair of downwardly extending legs and a first top therebetween.

17. The gate prop device of claim 11, wherein said swivel connector allows said first portion to pivot relative said swivel connector and moves said gate prop device between an in-use position and a not in-use position.

18. The gate prop device of claim 17, wherein said swivel connector allows said gate prop device to be placed on either side of a gate to which it is being attached thereby stopping said gate from being moved in either direction.

19. The gate prop device of claim 13, wherein a second clamp is configured to be used with said gate prop device.

20. The gate prop device of claim 19, wherein said second clamp is configured to attach to said horizontal beam.
